(19) United States
(12) Patent Application Publication
(10) Pub. No.: US 2002/0015128 A1
(43) Pub. Date: Feb. 7, 2002

(54) LCD driver IC chip

(76) Inventor: Hirokazu Sakaguchi, Chino-shi (JP)

Correspondence Address: HARNESS, DICKEY & PIERCE, PLC, P.O. BOX 828, BLOOMFIELD HILLS, MI, 48303, US

(21) Appl. No.: 09/885,858

(22) Filed: Jun. 20, 2001

(30) Foreign Application Priority Data
Jun. 21, 2000 (JP) 2000-186750

(51) Int. Cl. G02F 1/1345

(52) U.S. Cl. 349/149

(57) ABSTRACT

An LCD driver (liquid crystal display driver) IC chip 10 has an internal semiconductor device circuit including an input circuit 11 for inputting data, random access memory (RAM) 12 as a memory section, a logic circuit 13 as a data processing section, and an output circuit 14 including a latch circuit and outputting signals, in connection with each other. A bump electrode 15 is provided so as to correspond to input and output pads. Each bump electrode 15 is arranged so as to lie above some transistor devices (not shown in the drawing) in the input circuit 11 or the output circuit 14 and is provided with an insulating interlayer (not shown in the drawing) therebetween.

### BACKGROUND OF THE INVENTION

1. Technical Field of the Invention

The present invention relates to an LCD driver (liquid crystal display driver) IC chip which has a particularly narrow pad pitch and which must be reduced in size.

2. Description of the Related Art

LCD driver (liquid crystal display driver) IC chips are mounted in devices such as portable devices which must be further reduced in size in order to be fixed to liquid crystal display panels thereof with severely restricted mounting spaces. Thus, in view of the mounting space, the chips are rectangular and must be further reduced in size (miniaturization).

With the rapid progress of miniaturization in LCD driver IC chips, mounting technologies which can achieve fine-pitch terminal connection are required. Some known mounting technologies which may meet such a requirement are tape-automated-bonding (TAB) mounting technologies, which are used in tape carrier packaging (TCP), and chip-on-glass (COG) mounting technologies and chip-on-film/flexible (COF) mounting technologies using anisotropic conductive films (ACFs) etc.

These mounting technologies for reducing the mounting space, however, do not fully meet more severe restriction on the location for mounting the LCD driver IC chip. Accordingly, bump arrangements with narrower pitches and reduction in narrow sides of chips are still required by users.

As described above, in LCD driver (liquid crystal display driver) IC chips, a variety of ideas are incorporated into mounting technologies for reducing the mounting space. However, it is difficult to achieve a reduction in size which can meet user requirements, only by mounting technologies. If a reduction in size is attempted by drastically varying the design and size of the internal circuit, designing and developing becomes time-consuming. Thus, this attempt does not achieve driver IC chip products which have short market cycles and which must be completed within a short period of time, in light of cost.

It is an object of the present invention, in view of the above circumstances, to provide an LCD driver IC chip having a further reduced size without a significant change in the design rule for the internal circuit.

### SUMMARY OF THE INVENTION

An LCD driver IC chip in accordance with the present invention comprises a pad member connecting to an internal semiconductor device circuit and having an electrical connection region to the exterior, at least one insulating film formed at the peripheral portion of the pad member and around the electrical connection region, a metal layer covering the pad and the peripheral insulating film, and a bump electrode provided on the metal layer, wherein the bump electrode and the pad member lie above at least a part of the semiconductor device circuit with an insulating interlayer provided therebetween.

According to the LCD driver IC chip of the present invention, at least a portion corresponding to the size of the bump electrode lies in the region of the internal device circuit. This portion corresponding to the size of the bump electrode is not exposed to the exterior without a change in the chip size.

### BRIEF DESCRIPTION OF THE DRAWINGS

FIG. 1 is a plan view of a configuration of a main part of an LCD driver IC chip in accordance with an embodiment of the present invention.

FIG. 2 shows a partial configuration of the drawing shown in FIG. 1 of a bump layout of the present invention.

### DETAILED DESCRIPTION OF THE PREFERRED EMBODIMENTS

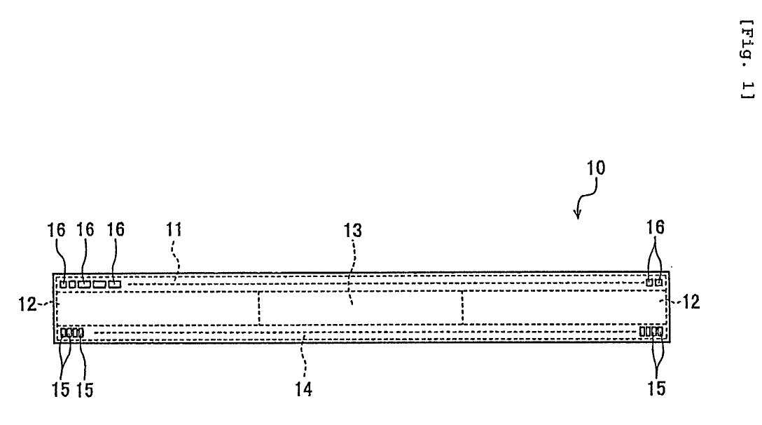

FIG. 1 is a plan view of a configuration of a main part of an LCD driver IC chip in accordance with an embodiment of the present invention. The LCD driver (liquid crystal display driver) IC chip 10 has an internal semiconductor device circuit including an input circuit 11 for inputting data, a memory section 12 comprising random access memory (RAM) etc., a logic circuit 13 as a data processing section formed of a gate array etc., and an output circuit 14 including a latch circuit and outputting signals, in connection with each other.

Bump electrodes 15 and 16 are provided so as to correspond to input and output pads. Each of the bump electrodes 15 and 16 is arranged so as to lie above some transistor devices (not shown in the drawing) in the input circuit 11 or the output circuit 14 and is provided with an insulating film (not shown in the drawing) therebetween.

In conventional IC chips, no devices are provided in the pad regions due to a possibility of shock during bonding. Similarly, LCD driver IC chips have circuit layouts in consideration of pad regions, that is, no devices are provided in the pad regions.

Since the LCD driver IC chip has a bump arrangement with a narrow pitch, the transistor configurations in the input circuit and the output circuit are uniformly dense, and are not damaged by the shock during connection to the exterior such as bonding. Thus, shock during connection does not cause damage on the insulating layer and output stage transistors, resulting in high reliability. The pad region is turned up by a via or the like so that the pad region lies above some transistor devices in the input circuit and output circuit. The external terminals, that is, the bump electrodes lie in the internal device circuit region of the chip and are not exposed to the exterior.

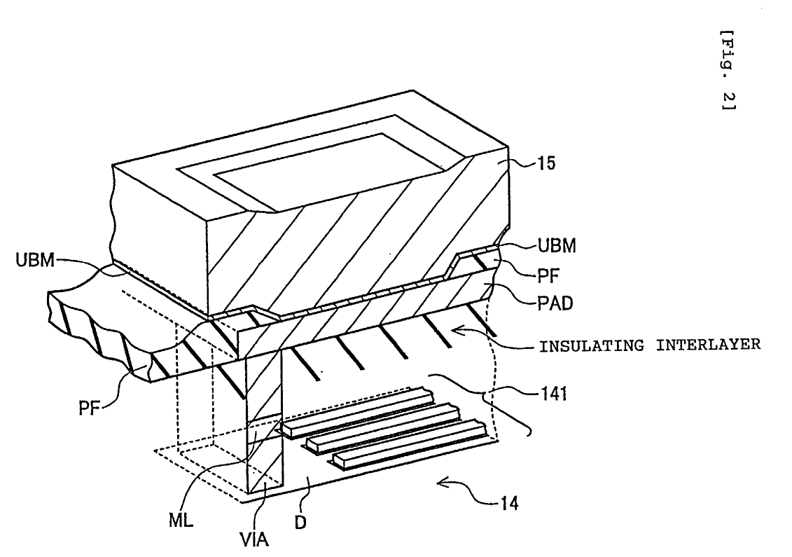

FIG. 2 shows a partial configuration of the drawing shown in FIG. 1 of a bump layout of the present invention. The bump 15 lies above the output circuit 14 of the LCD driver IC chip. Output stage transistors 141 are provided with a latch circuit (not shown in the drawing) in the output circuit 14. A via VIA is connected to the drain diffusion layer D of the output stage transistors 141. The via VIA is connected to a pad PAD lying above the output stage transistors 141 with an insulating interlayer provided therebetween. A passivation film PF is formed at the peripheral portion of the pad PAD. The pad PAD and the peripheral passivation film PF are covered by an under-bump metal layer UBM of a barrier metal. The bump electrode 15 is provided on the under-bump metal layer UBM.

In the insulating interlayer, a plurality of lead layers which connect to gate electrodes and sources of the transistor devices are provided, although not shown in the drawing. Thus, the via VIA is connected to the pad PAD through a lead layer ML. The insulating interlayer under the pad PAD has a thickness so as to be at least 400 to 800 nm distant from the lead layer ML.

Similarly, the bump electrode 15 is formed above a part of the input circuit 11 of the LCD driver IC chip 10 and is separated from the input circuit 11 by a via (VIA) connected to the diffusion layer which is connected to the input transistors in the input circuit 11, although this configuration is not shown in the drawing.

According to the embodiment of the present invention, the external terminal having a size of the bump electrode lies in the region of the internal device circuit of the chip and is not exposed to the exterior. Thus, at least in the short sides of the chip, a reduction in the size corresponding to the both bump electrodes is achieved (the size of the short sides can be reduced by about 200 μm). Since the design rule itself of the internal circuit is not significantly changed, the design development can be achieved within a short period of time, and the LCD driver IC chip is effective for driver products which have short market cycles and which must be completed within a short period of time.

As described above, in the LCD driver IC chip of the present invention, at least a portion corresponding to the size of the bump electrode lies in the region of the internal device circuit. This portion corresponding to the size of the bump electrode is not exposed to the exterior without a change in the chip size. As a result, an LCD driver IC chip having high reliability and a further reduced size is provided without a significant change in design rule for the internal circuit.

What is claimed is:

1. An LCD driver IC chip comprising:
a pad member connected to an internal semiconductor device circuit and having an electrical connection region to the exterior;
at least one insulating film formed at a peripheral portion of the pad member and around the electrical connection region;
a metal layer covering the pad member and the insulating film; and
a bump electrode provided on the metal layer,
wherein the bump electrode and the pad member lie above at least a part of the semiconductor device circuit with an insulating interlayer provided therebetween.

2. An integrated circuit chip comprising:
a device circuit;
a transistor in said device circuit;
a pad positioned above said transister and connected to said device circuit;
an insulating interlayer between said pad and said transistor; and
a bump electrode on said pad.

3. The chip of claim 2 wherein the device circuit further comprises are of an input circuit and an output circuit.

4. The chip of claim 2 wherein the pad further comprises one of an input pad and an output pad.

5. The chip of claim 2 wherein the bump is positioned above said transistor.

6. The chip of claim 2 further comprising a via interconnecting said pad and said device circuit.

7. The chip of claim 6 further comprising a lead layer of said insulating interlayer interconnnecting said via and said pad.

8. The chip of claim 2 further comprising a passivation film formed at a peripheral portion of the pad.

9. The chip of claim 8 further comprising a metal layer covering said passivation film and said pad.

10. The chip of claim 9 wherein said metal layer is interposed between said pad and said bump.
